(19) United States
(12) Patent Application Publication
(10) Pub. No.: US 2025/0371722 A1
(43) Pub. Date: Dec. 4, 2025

(54) METHODS AND SYSTEMS FOR NON-EARTH IMAGING BETWEEN NON-CO-ORBITAL SATELLITES

(71) Applicant: Maxar Intelligence, Inc., Westminster, CO (US)

(72) Inventor: John McKune, Westminster, CO (US)

(21) Appl. No.: 18/680,708

(22) Filed: May 31, 2024

(51) Int. Cl. G06T 7/246; H04N 23/69

(52) U.S. Cl. CPC G06T 7/248; H04N 23/69; G06T 2207/10032; G06T 2207/30241

(57) ABSTRACT

Examples of the present disclosure include a method of collecting a non-earth image of an object in space, the method including identifying a first orbital direction of the object in space, identifying a second orbital direction of an image capture device, determining a line of apparent motion between the object in space and the image capture device based on the identified first orbital direction and the identified second orbital direction, determining a residual motion across the image capture device, assessing an encounter window between the image capture device and the object in space, aligning sensors of the image capture device along the line of apparent motion, and when the object in space and the image capture device are within the encounter window, scanning at least the object in space by the image capture device along the line of apparent motion.

### BACKGROUND

Examples of the disclosure relate to non-earth imaging (NEI). In particular, examples of the disclosure relate to imaging an orbital object in space by an image capture device having a different orbit.

### SUMMARY

In one aspect of the present disclosure, a method of collecting a non-earth image of an object in space by an image capture device, the method including identifying a first orbital direction of the object in space, identifying a second orbital direction of the image capture device, determining a line of apparent motion between the object in space and the image capture device based on the identified first orbital direction and the identified second orbital direction, determining a residual motion across the image capture device, assessing an encounter window between the image capture device and the object in space, aligning sensors of the image capture device along the line of apparent motion, and when the object in space and the image capture device are within the encounter window, scanning at least the object in space by the image capture device along the line of apparent motion.

In an example, a resolution of the non-earth image of the object in space is about 2.5 cm. In various examples, assessing the encounter window includes determining a time at which a distance between the object in space and the image capture device is appropriate to perform the scanning of the object in space by the image capture device. In other examples, determining a scanning time of the object in space based on the assessed encounter window. In another example, the method further includes determining an orientation of the image capture device based on the determined scanning time. In a further example, aligning the sensors of the image capture device along the line of apparent motion includes aligning the sensors in a direction substantially perpendicular to the line of apparent motion. In another example, the sensors includes an elongated array of sensors. In yet a further example, the elongated array of sensors includes a plurality of multi-spectrum sensors and at least one panchromatic sensor therebetween. In another example, determining the line of apparent motion includes performing a combination of the first orbital direction and the second orbital direction.

In further examples, scanning the object in space by the image capture device along the line of apparent motion includes contemporaneously scanning the object in space in a first direction and in a second direction. In another example, scanning the object in space in the first direction includes rotating the image capture device along a first axis, and scanning the object in space in the second direction includes rotating the image capture device along a second axis. In a further example, scanning at least the object in space includes scanning a co-orbital second object in space. In another example, the method includes assessing the encounter window based on one or more of a solar position relative to the image capture device, a relative velocity of the object in space, a required scan rate, and a relative distance between the image capture device and the object in space.

The details of one or more techniques are set forth in the accompanying drawings and the description below. Other features, objects, and advantages of these techniques is apparent from the description, drawings, and claims.

### BRIEF DESCRIPTION OF THE DRAWINGS

FIG. 1 is a schematic diagram illustrating an image capture system for a non-earth object.

FIG. 2 is a schematic illustration of push broom imaging.

FIG. 3 is an illustration of an image capture device, in accordance with various examples of the disclosure.

FIG. 4 is an illustration of a sensor in an image capture device, in accordance with various examples of the disclosure.

FIGS. 5A and 5B are illustrations of scanning along a relative motion of an object in space, according to various examples of the disclosure.

FIG. 6 is a graph illustrating the determination of an encounter window, in accordance with various examples of the disclosure.

FIG. 7 is a flowchart illustrating a method of non-earth imaging between non-co-orbital satellites, in accordance with various examples of the disclosure.

Before one or more examples of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

### Selected Definitions

For the purposes of interpreting this specification, the following definitions will apply and whenever appropriate, terms used in the singular will also include the plural and vice versa. The definitions set forth below shall supersede any conflicting definitions in any documents incorporated herein by reference.

As used herein, the singular forms “a,” “an,” and “the,” include both singular and plural referents unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements or method steps. It is appreciated that the terms “comprising,” “comprises,” and “comprised of” as used herein comprise the terms “consisting of,” “consists,” and “consists of.”

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6, or ≥7, etc. of said members, and up to all said members.

Unless otherwise defined, all terms used in the present disclosure, including technical and scientific terms, have the meaning as commonly understood by one of ordinary skill in the art to which this disclosure belongs. By means of further guidance, term definitions are included to better appreciate the teaching of the present disclosure. In the following passages, different aspects of the present disclosure are defined in more detail. Each aspect so defined may be combined with any other aspect or aspects unless clearly indicated to the contrary.

Reference throughout this specification to “one example” or “an example” means that a particular feature, structure or characteristic described in connection with the example is included in at least one example of the present disclosure. Thus, appearances of the phrases “in one example” or “in an example” in various places throughout this specification are not necessarily all referring to the same example, but may. Furthermore, the particular features, structures or characteristics may be combined in any suitable manner, as would be apparent to a person skilled in the art from this disclosure, in one or more examples. Furthermore, while some examples described herein include some, but not other features included in other examples, combinations of features of different examples are meant to be within the scope of the disclosure, and form different examples, as would be understood by those in the art. For example, in the appended claims, any of the claimed examples can be used in any combination.

When the terms “about” or “substantially” are used in this specification in connection with a numerical value, it is intended that the associated numerical value include a tolerance of ±10% around the stated numerical value.

In the present disclosure, reference is made to the accompanying drawings that form a part hereof, and in which are shown by way of illustration only of specific examples in which the present disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims.

### Non-Earth Imaging (NEI)

Non-earth imaging (NEI), also referred to as satellite-to-satellite imaging, is the imaging of a non-earth object such as, e.g., a satellite, an active or inactive spacecraft, a rocket body, space debris, or other object, from an image capture device that is also in space and is part of, e.g., another satellite. The non-earth object may be referred to herein as a target. For example, NEI is achieved by using space-based sensors located at the image capture device to capture high-resolution images of the target. In other words, NEI includes the use of a space-based imaging system that is typically used for earth imaging to image an object in space.

The ability to image an object in space may hinge on a plurality of factors including, e.g., conjunction opportunities as indicated by the laws of orbital mechanics because any two orbits intersect at two points and an encounter window may thus be determined. Another factor may include a knowledge of the target's position and velocity. Yet another factor may include the slewing and scanning capabilities of the imaging satellite and the command structure thereof, because not all encounters are feasible due to, e.g., excessive relative angular rates, or position with respect to the sun. Other factors include characteristics of the image forming device and the mode of operation thereof such as, e.g., line rates, scan directions, the ability to change focus. For example, the focus may be actively adjusted in order to achieve a desired or required image quality, also referred to as in-focus image. Additional more generic factors may include solar interference and background illumination.

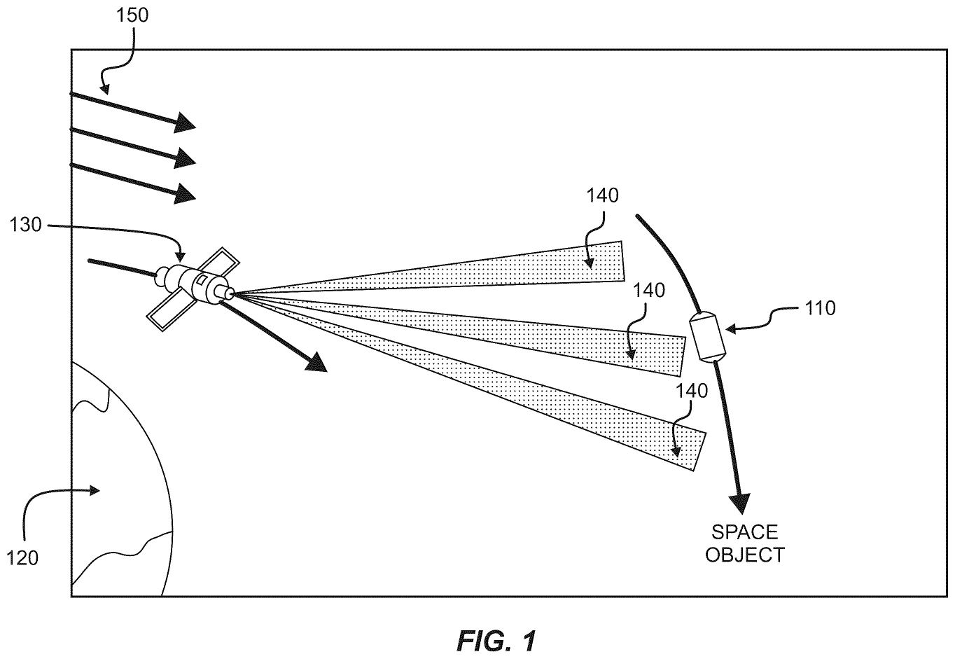

FIG. 1 is a schematic diagram illustrating an image capture system for a non-earth object. In FIG. 1, an object in space 110, or target 110, is illustrated as orbiting around the earth 120. In examples, a sensor 130 such as, e.g., an image capture device or an imaging satellite, is positioned in space to capture one or more images or videos of the non-earth object 110. The sensor 130 and the object in space 110 may be in substantially different orbits. In operation and according to various examples, the sensor or image capture device 130 may capture images of the non-earth object 110 via push broom imaging, as illustrated in the successive lines 140 of image capture. As discussed above, examples of the disclosure provide a method of capturing an image of the non-earth object, or target, 110 based on a number of constraints such as, e.g., a position and location 150 of the sun, an orbital direction of the object 110, an orbital direction of the sensor or image capture device 130, and a distance or range between the object 110 and the sensor or image capture device 130.

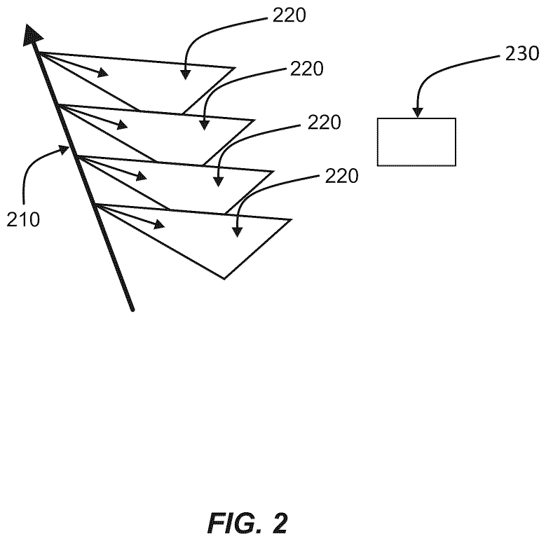

FIG. 2 is a schematic illustration of push broom imaging. In FIG. 2, as an image sensor such as, e.g., the sensor 130 illustrated in FIG. 1, travels along the direction 210, a plurality of image capture events, or scans, 220, are performed by the image capture device to capture an image of the target or object 230. Push broom imaging devices, such as the sensor 130 of FIG. 1, also referred to herein as push broom scanners, typically use a line of detectors arranged perpendicularly to the flight direction 210 of the sensor. As the satellite body is rotated to create the motion across the image capture device's focal plane along direction 210, the image is collected one line or scan 220 at a time, with all of the pixels in a given line 220 being measured simultaneously or contemporaneously. Accordingly, each line 220, being taken at a slightly different time, is combined together to form a two-dimensional image of the object 230 being imaged.

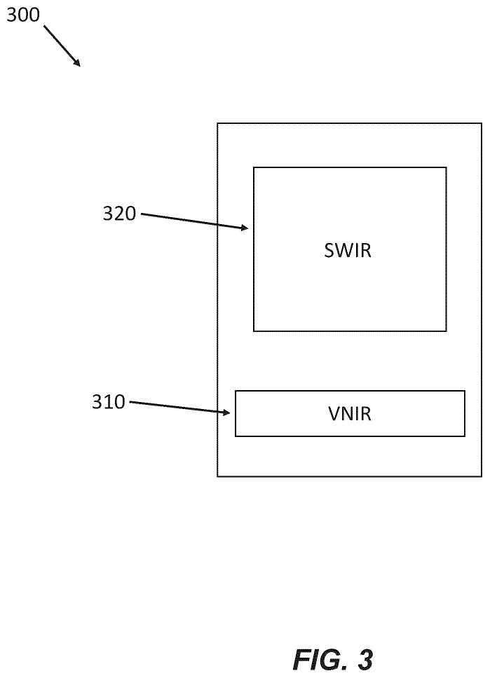

FIG. 3 is an illustration of an image capture device, in accordance with various examples of the disclosure. In FIG. 3, the image capture device 300 is configured to scan at a plurality of frequencies, from short wave infrared (SWIR) to visible near infrared (VNIR). In the example illustrated in FIG. 3, the image capture device 300 includes a main or VNIR sensor array 310 and an auxiliary or SWIR sensor array 320. Accordingly, an object in space may be scanned, or imaged, at a range of different frequencies. For example, a time of scanning the VNIR sensor array 310 may be about 0.35 seconds, the time of scanning the SWIR sensor array 320 may be 1.50 seconds, and the time of scanning both the VNIR sensor array 310 and the SWIR sensor array 320 may be 2.44 seconds.

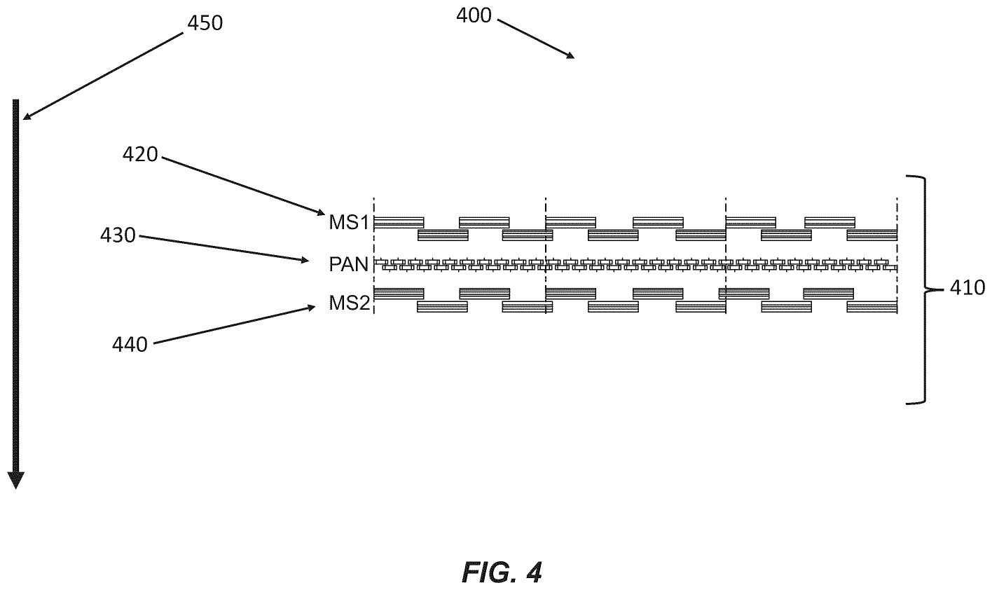

FIG. 4 is an illustration of a sensor in an image capture device, in accordance with various examples of the disclosure. In FIG. 4, the sensor 400 includes an array 410 of sensors extending along a width thereof. The array 410 of sensors may include multi-spectral 1 sensors 420, panchromatic sensors 430, and multi-spectral 2 sensors 440. Accordingly, as the object in space is being, e.g., scanned along direction 450, the scan successively starts with the multi-spectral 1 sensors 420, continues through the panchromatic sensors 430, and then through the multi-spectral 2 sensors 440. Scanning as discussed herein takes some amount of time as the scan moves from the multi-spectral 1 sensors 420 to the multi-spectral 2 sensors 440. Positioning the sensor 400 is further discussed below.

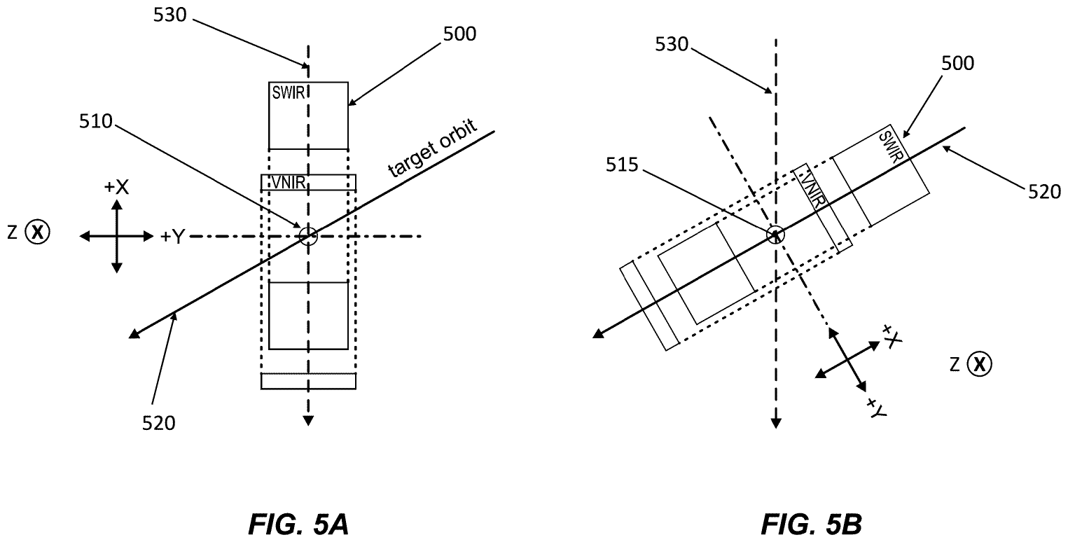

FIGS. 5A and 5B are illustrations of scanning along a relative motion of an object in space, according to various examples of the disclosure. FIG. 5A is illustrative of the scanning of the object in space which orbital direction is known, e.g., where the target object in space is co-orbital to the image capture device or satellite 500. An object in space being “co-orbital” to the image capture device 500 may be, e.g., a situation where the image capture device or satellite 500 performing maneuvers to setup a Rendezvous & Proximity Operations (RPO) orbit with respect to the object in space. In an RPO scenario, the imaging satellite is essentially flying along with the target, with either a fixed offset or with low relative rates. For example, FIG. 5A illustrates the image capture device 500 performing a scan of an object in space that is traveling along an orbital direction 520 by aligning a boresight 510 of the image capture device 500 along a line of apparent motion 530 between the image capture device 500 and the object in space. In an example, the scan is performed along the apparent motion 530 of the object in space with respect to the image capture device 500. With reference to FIG. 3, the scan may be performed from the SWIR range down to the VNIR range, and the time of scanning of the object in space is based on the time it takes to scan across the entire range. With respect to FIG. 4, the time of scanning also depends on the time necessary for the sensors 420, 430 and 440 to image the object in space. The scanning of the object in space at the boresight 510 along the line of apparent motion 530 may include rotating the image scanning device 500 around the Y axis.

FIG. 5B illustrates the image capture device 500 performing a scan of an unknown object in space along a boresight 515, where the unknown object in space is co-orbital to, or in the same, orbital direction 520. For example, the unknown object may be ahead of, or behind, a target object. Accordingly, as the unknown object in space may travel along the orbital direction 520, in order to capture both the unknown object and the target object, the image capture device 500 may be rotated around an axis Z in order to align the boresight 515 with the co-orbital unknown object in space. In this case, the image capture device may be configured to have a dual axis rotation capability.

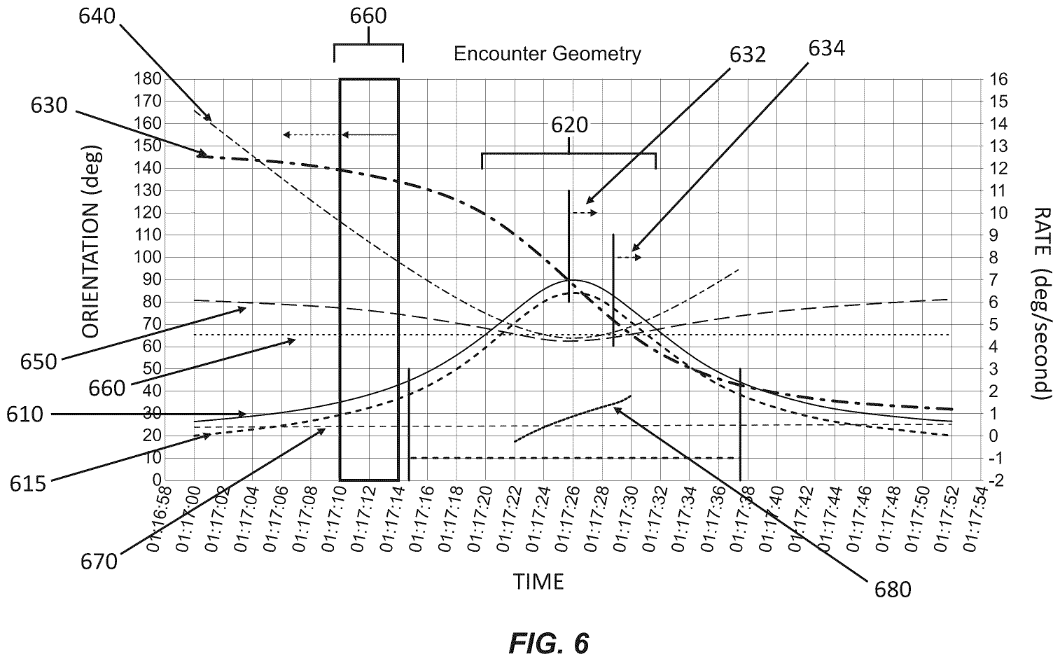

FIG. 6 is a graph illustrating the determination of an encounter window, in accordance with various examples of the disclosure. The x-axis of the graph in FIG. 6 represents time, and the y-axes represent the relative geometry of the line-of-sight between the imaging system and the target object with respect to various considerations and constraints. The right-hand y-axis represents both the resulting angular rate (in deg/second) and the Space Sample Distance (SSD or “resolution”) in centimeters (cm) orientation and rate. For example, a resolution of the non-earth image of the object in space, which is a linear function of the range to the object multiplied by the IFOV, for a range of about 50 km, the SSD may be 50 km*0.5 u-rad, or about 2.5 cm.

In examples, an encounter window is window of opportunity in terms of time at which the distance or orientation between the object in space and the image capture device allows to perform a scan of sufficient quality, e.g., substantially free of smear, may be obtained. Obtaining a scan of sufficient quality may depend on a plurality of factors or constraints such as, e.g., the distance between the object in space and the image capture device, the apparent angular velocity of the line-of-sight to the object in space from the image capture device, the angular separation of the sun with respect to the line-of-sight to the object in space from the image capture device, and the like. For example, the distance between the image capture device and the object in space may be relevant to the quality of the scan of the object in space. In FIG. 6, the curve 640 illustrates the SSD, or resolution, of the resulting image, and the curve 650 illustrates the off-nadir angle (ONA) of the image capture device. Off-Nadir Angle (ONA) 650 describes the angular separation between nadir and the target object from the imaging system's perspective. The curve 660 describes the angle from nadir to the earth's horizon, such that when the ONA curve 650 goes above the curve 660, the target object is seen against a background of space as opposed to a background of the earth when the ONA curve 650 is below the curve 660. Accordingly, as the quality of the scan may be greater as the image capture device and the object in space are closer together, a preferred window, also referred to as encounter window, to scan the object in space may be, e.g., the central portion 620. However, other considerations may shift the encounter window to a different location, as further discussed below.

In various examples, the curve 670 line represents the elevation of the sun for a point directly beneath the target object. Thus, the curve 670 provides an indication of the additional lighting the target object may receive from reflected earthshine in addition to the lighting received directly from the sun. The more earthshine that is available, the more hard shadows from the sun's illumination may be filled. The curve 680 represents the elevation of the sun for a point on the earth directly behind the target object from the perspective of the imaging system. This data may be relevant when the target object is seen below the earth's horizon, which may indicate whether the background earth is in daylight or darkness. A lit earth background may, e.g., help outline otherwise dark features on the target object.

For example, if the relative angular rate, or relative velocity, between the image capture device and the object in space is too high, scanning the object in space with sufficient quality may be challenging. As illustrated in FIG. 6, the relative angular rate 610 includes a high relative rate portion at the center portion 620 of the chart, and lower rate portions outside of the center portion 620. Accordingly, a desirable encounter window between the image capture device and the object in space may be outside of the center portion 620 so that the relative rate 610 is low enough to allow for a scan of sufficient quality to be performed. In examples, the scan rate 615 of the image capture device follows the relative rate 610, and also shows a more appropriate range of scanning that is outside of the center portion 620.

Another factor to take into account when determining a desirable encounter window may include the position of the sun with respect to the image capture device. In FIG. 6, the curve 630 illustrates the relative position of the sun. For example, if the angle to the sun is too close to the image capture device, which is illustrated in FIG. 6 by the range of distance 632, then the quality of the scan may be adversely affected and may fall below an acceptable range of quality. In another example, if the sun directly faces the image capture device, as illustrated in the range 634 of FIG. 6, then the quality of the scan may also be deteriorated. When the sun is located behind the image capture device, the quality of the resulting scan may be of sufficient quality when taking into account other constraints.

In view of the above factors and constraints, including the relative distance between the image capture device and the object in space across time, the relative rate of the object in space, and the location of the sun, a desirable encounter window may be the window of time 660 instead of the central window 620. During this encounter window 660, the combination of the above constraints and factors is more likely to result in a scan of the object in space that is of desirable or sufficient quality.

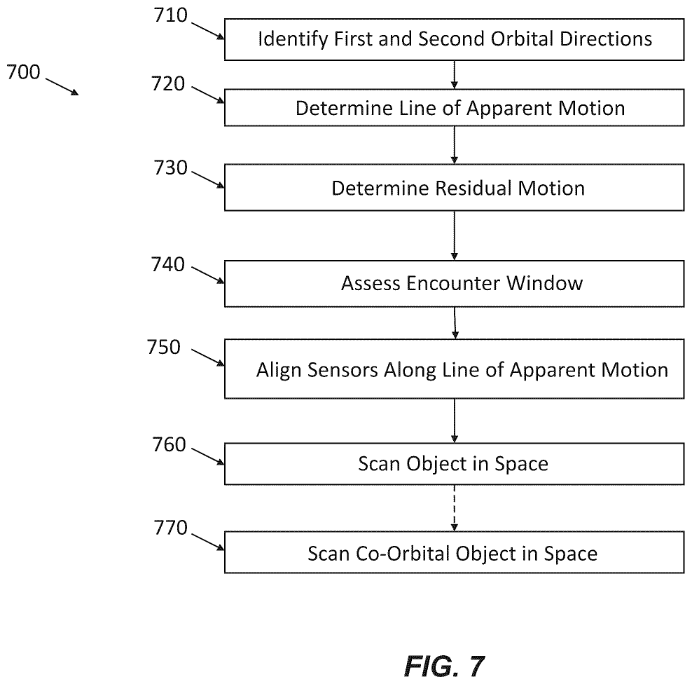

FIG. 7 is a flowchart illustrating a method of non-earth imaging between non-co-orbital satellites, in accordance with various examples of the disclosure. In FIG. 7, the method 700 includes operation 710, during which a first orbital direction of the object in space is identified. The orbit of the object in space may be identified from publicly available data, or may be obtained via other data sources. During operation 710, the method also includes identifying a second orbital direction of the image capture device. For example, the second orbital direction may be the orbital direction of a satellite that carries or holds the image capture device.

During operation 720, the method 700 includes determining a line of apparent motion between the object in space and the image capture device. With reference to FIG. 1, the line of apparent motion may be a line of motion between the object in space 110 and the satellite that holds the image sensor 130 . . . . For example, the line of apparent motion, or relative motion, between the object in space and the image capture device may be determined based on the identified first orbital direction and the identified second orbital direction. For example, as the first orbital direction may be characterized by a first vector including a first position and first velocity, and the second orbital direction may be characterized by a second vector including a second position and second velocity, the addition, or combination, of these two vectors may result in the apparent motion, or the relative motion, of the object in space with respect to the image capture device. The addition, or combination of the vectors of the positions, velocities and directions can be performed via well-known mathematical techniques of vector operations. Accordingly, determining the line of apparent motion may include performing a combination of the first orbital direction and the second orbital direction.

During operation 730, the method 700 includes determining a residual motion across the image capture device. In examples, the residual motion, or residual rate, may be or include the motion of the image capture device that is sufficient to expose the object in space to all the sensors, or sensor arrays, within the image capture device. The residual motion, or residual rate, may be the combination of a clock rate of the image capture device such as, e.g., 20,000 lines per second, with the projected angular size of a single pixel on the image capture device. For example, the residual (or native) scanning body rate is equal to the line rate of the camera multiplied by the Instantaneous Field-Of-View (IFOV). Typically, the IFOV is computed by dividing the physical size of the detector pixel by the focal length of the telescope. For example, with a panchromatic detector size of about 8 microns, and a focal length of about 16 meters, the IFOV is about 0.5 micro-radians. When multiplied by a nominal line rate of about 20,000 lines/sec, the native scan rate may thus be equal to about 0.01 radians/sec. With reference to FIG. 4 discussed above, the residual motion may be the motion from the multi-spectral 1 sensors 420 to the panchromatic sensors 430 and then to the multi-spectral 2 sensors 440.

During operation 740, the method 700 includes assessing an encounter window between the image capture device and the object in space. For example, assessing the encounter window may include determining an appropriate distance between the object in space and the image capture device to perform the scanning of the object in space by the image capture device. As discussed above with reference to FIG. 6, assessing the encounter window includes determining a window of time during which the scan of the object in space may be of sufficient quality by taking into account a plurality of factors such as, e.g., the relative distance between the image capture device and the object in space across time, the relative velocity of the object in space, and the location of the sun, also referred to herein as solar position. In another example, operation 740 further includes determining a scanning time of the object in space based on the assessed encounter window. The scanning may include, e.g., a time of the residual motion determined during operation 730 and during which the sensors of the sensor array of the image forming device, e.g., as illustrated in FIG. 4, can capture an image of the object in space. In another example, an orientation of the image capture device may be determined based on the determined scanning time.

When the encounter window has been determined during operation 740, operation 750 includes aligning sensors of the image capture device along the line of apparent motion. The sensors may include an elongated array of sensors that include a plurality of multi-spectrum sensors and at least one panchromatic sensor therebetween. For example, aligning the sensors along the line of relative motion may allow the image capture device to effectively scan the object in space. For example, aligning the sensors of the image capture device along the line of apparent motion may include aligning the sensors in a direction substantially perpendicular to the line of apparent motion.

When the object in space and the image capture device are within the encounter window, operation 760 includes scanning at least the object in space by the image capture device along the line of apparent motion. An illustration of operation 760 is illustrated in FIGS. 2 and 5A discussed above. In an example, scanning the object in space by the image capture device along the line of apparent motion may include contemporaneously scanning the object in space in a first direction and in a second direction. For example, scanning the object in space in the first direction includes rotating the image capture device along a first axis, and scanning the object in space in the second direction includes rotating the image capture device along a second axis. The scan rates in the first axis and in the second axis may also be determined as a function of the relative motion azimuth. For example, a relative motion azimuth equal to zero indicates that the line or relative motion is aligned with the x-axis of the image capture device.

In other examples, when another object, e.g., heretofore unknown object, is co-orbital to the first orbital direction, then operation 770 may include scanning the co-orbital object in space. In examples, because the direction of the co-orbital object may be different from the direction of the first orbital direction, operation 770 may also include rotating the image capture in order to align the sensors thereof along a line of apparent motion between the co-orbital object and the image capture device. An illustration of operation 770 is illustrated in FIG. 5B discussed above.

Although various examples and examples are described herein, those of ordinary skill in the art will understand that many modifications may be made thereto within the scope of the present disclosure. Accordingly, it is not intended that the scope of the disclosure in any way be limited by the examples provided.

What is claimed is:

1. A method of collecting a non-earth image of an object in space by an image capture device, the method comprising:
identifying a first orbital direction of the object in space;
identifying a second orbital direction of the image capture device;
determining a line of apparent motion between the object in space and the image capture device based on the identified first orbital direction and the identified second orbital direction;
determining a residual motion across the image capture device;
assessing an encounter window between the image capture device and the object in space;
aligning sensors of the image capture device along the line of apparent motion; and
when the object in space and the image capture device are within the encounter window, scanning at least the object in space by the image capture device along the line of apparent motion.

2. The method of claim 1, wherein assessing the encounter window comprises determining a time at which a distance between the object in space and the image capture device is appropriate to perform the scanning of the object in space by the image capture device.

3. The method of claim 1, further determining a scanning time of the object in space based on the assessed encounter window.

4. The method of claim 3, further comprising determining an orientation of the image capture device based on the determined scanning time.

5. The method of claim 1, wherein aligning the sensors of the image capture device along the line of apparent motion comprises aligning the sensors in a direction substantially perpendicular to the line of apparent motion.

6. The method of claim 1, wherein the sensors comprise an elongated array of sensors.

7. The method of claim 6, wherein the elongated array of sensors comprises a plurality of multi-spectrum sensors and at least one panchromatic sensor therebetween.

8. The method of claim 1, wherein determining the line of apparent motion comprises performing a combination of the first orbital direction and the second orbital direction.

9. The method of claim 1, wherein scanning the object in space by the image capture device along the line of apparent motion comprises contemporaneously scanning the object in space in a first direction and in a second direction.

10. The method of claim 9 wherein:
scanning the object in space in the first direction comprises rotating the image capture device along a first axis; and
scanning the object in space in the second direction comprises rotating the image capture device along a second axis.

11. The method of claim 1, wherein scanning at least the object in space comprises scanning a co-orbital second object in space.

12. The method of claim 1, wherein the method comprises assessing the encounter window based on one or more of:
a solar position relative to the image capture device;
a relative velocity of the object in space;
a required scan rate; and
a relative distance between the image capture device and the object in space.

13. The method of claim 1, wherein a resolution of the non-earth image of the object in space is about 2.5 cm.
